(19) United States
(12) Patent Application Publication
(10) Pub. No.: US 2025/0215646 A1
(43) Pub. Date: Jul. 3, 2025

(54) DIMENSIONALLY STABLE SEPARATOR FOR ELECTROCHEMICAL ELEMENTS

(71) Applicant: DELFORTGROUP AG, Traun (AT)

(72) Inventors: Sven PLAPPERT, Schwaz (AT); Dietmar VOLGGER, Gnadenwald (AT)

(21) Appl. No.: 18/273,722

(22) PCT Filed: Jan. 27, 2022
(86) PCT No.: PCT/EP2022/051841

§ 371 Date: Apr. 25, 2024

(30) Foreign Application Priority Data
Jan. 29, 2021 (DE) 102021102055.7

(51) Int. Cl. D21H 13/08; D04H 1/4258; D04H 1/435; D04H 1/4382; D04H 1/44; D21F 11/02; H01G 9/02; H01G 11/52; H01M 10/0525; H01M 50/403; H01M 50/429; H01M 50/44

(52) U.S. Cl. CPC D21H 13/08; D04H 1/4258; D04H 1/435; D04H 1/43835; D04H 1/44; D21F 11/02; H01M 10/0525; H01M 50/403; H01M 50/4295; H01M 50/44; D10B 2401/063; D10B 2505/00; H01G 9/02; H01G 11/52

(57) ABSTRACT

A separator for an electrochemical element is shown, in which at least 50% of the mass of the separator is formed by fibrillated regenerated cellulose fibers, wherein, including the fibrillated regenerated cellulose fibers, at least 70% and at most 100% of the mass of the separator is formed by cellulose fibers, and wherein the separator is calendered, and wherein under tensile load in the machine direction in accordance with ISO 1924-2:2008, the separator reaches its 0.1% yield point at an elongation of no less than 0.5% and no more than 2.0%. A method of manufacturing such a separator is also disclosed.

### FIELD OF THE INVENTION

The invention relates to a separator for electrochemical elements that is substantially formed by cellulose fibers and is provided with a high dimensional stability by means of a particular production process.

### BACKGROUND AND PRIOR ART

An electrochemical element typically comprises at least a positive electrode, a negative electrode, an electrolyte, a separator, a casing, and current collectors. The separator is impregnated with the electrolyte and is intended to electrically separate both electrodes. In this regard, it should also, as far as possible, allow for an unhindered flow of ions between the electrodes, so that the electrochemical element has advantageous properties, in particular rapid charging and the option to draw high currents.

These requirements on the separator mean that it should be as thin as possible, so that the path of the ions from one electrode to the other through the pores of the separator is short and a high volumetric energy density of the electrochemical element can be achieved, and it ought to have a high porosity. In particular, if the electrochemical element is an accumulator, the porosity should not be formed by a few large pores, but rather by a plurality of small pores, because small pores can inhibit the growth of crystals at the electrodes, in particular dendrites. These crystals can short-circuit the accumulator and thus reduce its lifespan and performance. Furthermore, the porosity should be as constant as possible over the entire surface of the separator.

The separator should be chemically stable with respect to the electrolyte, because electrochemical elements can be recharged multiple times and are typically in use for several years. The separator should therefore also be stable in oxidizing or reducing environments.

For safety reasons, the separator should have good thermal stability in order to limit the risk of fire in case of damage to the electrochemical element.

However, at times during production of electrochemical elements, the problem occurs that their performance parameters vary, which can be traced back to varying quality of the separator.

Thus, there is an interest in having a separator available that enables high and uniform-quality electrochemical elements to be manufactured.

### SUMMARY OF THE INVENTION

The objective of the invention is to provide a separator for electrochemical elements that enables electrochemical elements with good performance parameters to be manufactured with a high productivity

This objective is achieved by a separator for electrochemical elements according to claim 1, an electrochemical element comprising this separator according to claim 40 and a process for manufacturing a separator for electrochemical elements according to claim 41. Further advantageous embodiments are provided in the dependent claims.

The inventors have found that variations in the performance behavior of electrochemical elements are in practice caused not only by variations in the manufacturing process, but in particular also by mechanical loads on the separator in the process for manufacturing such an electrochemical element. In this context, not only is the tensile strength of the separator important, but it is essential that the separator is dimensionally stable, i.e., that under the loads occurring during manufacture of the electrochemical elements, the separator does not undergo plastic deformation, i.e., irreversible deformation. Such plastic deformation can change the pore structure of the separator in a negative way and can lead to poorer performance parameters of the electrochemical element or can increase waste during production of electrochemical elements.

The inventors have found that said objective can be achieved by a separator for electrochemical elements, wherein at least 50% of the mass is formed by fibrillated regenerated cellulose fibers and wherein, including the fibrillated regenerated cellulose fibers, at least 70% and at most 100% of the mass of the separator is formed by cellulose fibers, wherein furthermore, the separator is calendered and under tensile load in the machine direction in accordance with ISO 1924-2:2008, reaches its 0.1% yield point at an elongation of no less than 0.5% and no more than 2.0%.

In this regard, the fact that the 0.1% yield point is achieved at an elongation of 0.5% or higher is a measure of said dimensional stability, recognized as essential to achieving the objective.

According to the findings of the inventors, the fibrillated regenerated cellulose fibers enable the separator to be provided with a homogeneous pore structure and a high porosity. In contrast to cellulose fibers, the fibrillated regenerated cellulose fibers are less variable in their geometry and therefore generate a homogeneous pore structure but contribute less to the strength of the separator than cellulose fibers. The chemical purity of fibrillated regenerated cellulose fibers is a further advantage over cellulose fibers.

Although, the inventors understand that advantageous separators can already be obtained with a proportion of 50% of fibrillated regenerated cellulose fibers, the total proportion of cellulose fibers, i.e., including the regenerated cellulose fibers, should be at least 70%, each with respect to the mass of the separator, in order to provide the separator with an appropriate mechanical strength. Furthermore, the cellulose fibers offer advantages over plastic films with respect to fire safety, thermal stability, and ecological aspects.

A separator with these components can in principle be produced by means of paper manufacturing processes that are known in the art, but without specific measures to achieve dimensional stability during production, it would not have the desired properties. If separators that are known in the art are stretched in a tensile test, then the deformations are at first linear elastic deformations. This means that the deformations are proportional to the applied force and are completely reversible again after removal of the load. Upon further stretching in the tensile test, there is a small transitional region with non-linear elastic deformation, in which the applied force is therefore no longer proportional to the elongation, but after removal of the load, the deformation is still completely reversible. At even higher elongations, plastic deformation occurs, i.e., an irreversible deformation, which no longer disappears after removal of the load. Such an irreversible deformation is not desired because it changes the pore structure of the separator in an unfavorable manner and can create microscopic fractures and therefore worsens the properties of an electrochemical element manufactured therefrom. In addition, the waste during manufacturing of an electrochemical element can increase.

However, during the manufacture of an electrochemical element, loads may arise which leave irreversible deformations in the separator. This can occur, for example if, during the manufacture of the electrochemical element, for example during the manufacture of cylindrical cells, the separator is exposed to shocks, high accelerations or speed differences. Because irreversible deformations can occur at loads which are in fact far below the tensile strength of the separator, they are usually not noticed, but in general deteriorate the properties of the electrochemical element.

The elastic and plastic behavior of separators can be determined in a tensile test. Such a tensile test can be carried out in accordance with ISO 1924-2:2008. In this test, a 15 mm wide sample strip is stretched at a constant speed of 20 mm/min until it breaks. During stretching, the elongation and the force are recorded and a stress-strain diagram is calculated therefrom.

FIG. 1 shows, by way of example, a stress-strain diagram for a separator according to the invention. The stress-strain curve 1 is shown here as a diagram, in which the horizontal axis 2 shows the elongation and the vertical axis 3 shows the tensile stress. Starting from an almost stress- and strain-free state 4, the elongation is increased at a constant rate of 20 mm/min, until the sample strip breaks at an elongation 5 and the corresponding tensile stress 6. Initially, a linear elastic deformation occurs here, indicated by the dashed line 7. The slope of this line 7 is the Young's modulus, which can also be determined from the tensile test in accordance with ISO 1924-2:2008. It is usual to determine the 0.1% yield point from the stress-strain curve 1 as well as the linear elastic behavior line 7. The line 7 is then shifted parallel along the horizontal axis 2 until it intersects the horizontal axis 2 at an elongation of 0.1% and a parallel line 8 is thus obtained. The intersection 9 between this offset line 8 and the stress-strain curve 1 shows the 0.1% yield point, which is characterized by the corresponding elongation 10 and the tensile stress 11. Usually, it is assumed that at elongations higher than the intersection 9, irreversible deformations will occur, while at smaller elongations, the behavior is still mainly elastic.

In the context of this invention, the 0.1% yield point should always be understood to be the point 9 described above consisting of the corresponding elongation 10 and tensile strength 11. Equipment for testing the tensile strength in accordance with ISO 1924-2:2008 is often capable of determining the 0.1% yield point automatically.

The tensile strength is given as the force per unit area (MPa) with respect to the cross-sectional area, but it can also be multiplied by the thickness of the separator so that it relates only to the width and is then given in kN/m.

To manufacture an electrochemical element from a separator, above all, its mechanical properties in the machine direction are important. The machine direction here is that direction in which the fibrous web runs through the machine during manufacture of the separator. The direction orthogonal thereto and lying in the plane of the fibrous web is the cross direction.

According to the findings of the inventors, it is therefore important that the 0.1% yield point for the separator according to the invention in the machine direction is at high stresses and elongations. Such a separator is capable of absorbing a lot of deformation energy without irreversible deformations occurring. Thus, it has a high elastic energy absorption and hence a high dimensional stability. According to FIG. 1, the elastic energy absorption here is given by the area delimited by the stress-strain curve 1, the horizontal axis 2 and the line connecting points 9 and 10. To a good approximation, the elastic energy absorption can also be calculated by the area of the triangle formed by the points 4, 9 and 10.

The elastic energy absorption is a volumetric parameter and thus has the units of energy per volume (kJ/m³). In the practical application for separators, though, it is sometimes multiplied by the thickness of the separator, so that it can be given as the energy per unit area of the separator, in J/m².

The elastic energy absorption should be differentiated from the total tensile energy absorption (TEA), because the latter describes the total energy absorbed to break and not just that which can be absorbed up to the occurrence of irreversible deformations.

The fibrillated regenerated cellulose fibers in the separator according to the invention are essential to the generation of a good pore structure. The fibrillation of the regenerated cellulose fibers increases their surface area and thus the area that is available for hydrogen bonding. In spite of this, due to their round cross section, they still suffer from some disadvantages in respect of mechanical strength, which can be overcome by appropriate manufacturing processes so that the 0.1% yield point of the separator can be shifted to higher elongations and stresses.

FIG. 2 shows two fibrillated regenerated cellulose fibers, 20 and 21, which cross over each other. Due to the round cross section the fibrillated regenerated cellulose fibers 20 and 21, in theory they only touch at a single point 22. Only a few hydrogen bonds can be formed at the small area 22, whereupon the strength, and correspondingly the 0.1% yield point, of a separator manufactured in this manner are not good. The fibrillated regenerated cellulose fibers 20 and 21 can be pressed flat by calendering, so that the fibers 23 and 24 are obtained. This generates a larger contact area 25, which allows for more hydrogen bonding and thus leads to a higher strength and a better 0.1% yield point.

According to the understanding of the inventors, for the purposes of improved dimensional stability, it is not just a variation in the fiber cross section that is important. FIG. 3 shows two cellulose fibers, 30 and 31, which cross each other approximately at right angles 33. Even if the cellulose fibers 30 and 31 are pressed flat, the contact area 32 is relatively small. The cellulose fibers 34 and 35, however, cross each other at a smaller angle 37, whereupon a substantially larger contact area 36 between the fibers is produced and the strength and the 0.1% yield point are improved. This improvement primarily occurs in the direction of the longitudinal axes of the cellulose fibers 34 and 35, while in the direction orthogonal thereto, the improvement is substantially smaller, or it may even become worse. The angle 37 between the cellulose fibers should therefore not become too small. As will be explained below, by making adjustments to the manufacturing process, in particular the web tension, temperature and moisture, it is possible to stretch the cellulose fibers and potentially deform them plastically as well, and thereby on average orientate them at an angle such that the 0.1% yield point is significantly shifted to higher stresses and elongations.

A fiber-based separator according to the invention, which enables the manufacture of electrochemical elements with good performance parameters with high productivity, thus in particular has an improved dimensional stability which can be quantitatively described in that under tensile load in the machine direction in accordance with ISO 1924-2:2008, the separator reaches its 0.1% yield point only at an elongation of 0.5% or higher.

The inventors have been able to demonstrate that such a dimensionally stable, fiber-based separator can be manufactured from the said components if the manufacturing process is adapted accordingly. The influence of certain settings in the manufacturing process, which have a positive effect on the dimensional stability of the fibrous web, in particular the influence of web tension, temperature and moisture, will be further explained below and demonstrated in experiments, and these measures are based on the theoretical understanding of the inventors that was explained with reference to FIG. 2. It is emphasized, however, that the invention is not limited to these specific measures in the manufacture and that other modifications to the manufacturing process are encompassed by the invention, provided that they lead to the 0.1% yield point according to the invention for the separator. In the same way, no restriction of the invention should be deduced from the theoretical explanation with reference to FIG. 2, which corresponds to the current understanding of the inventors.

at least 50% of the mass of the separator according to the invention is formed by fibrillated regenerated cellulose fibers. These fibers generate a good pore structure for a separator. Preferably, the proportion of fibrillated regenerated cellulose fibers is higher and is at least 55% and at most 100% and particularly preferably at least 60% and at most 95% of the mass of the separator.

The fibrillated regenerated cellulose fibers are preferably solvent-spun regenerated cellulose fibers, particularly preferably Lyocell® fibers.

The linear density of the fibrillated regenerated cellulose fibers before fibrillation is important for the fibrillation of the fibers. Preferably, the mean linear density of the fibrillated regenerated cellulose fibers before fibrillation is at least 0.8 g/10000 m (0.8 dtex) and at most 3.0 g/10000 m (3.0 dtex) and particularly preferably at least 1.0 g/10000 m (1.0 dtex) and at most 2.5 g/10000 m (2.5 dtex).

The length of the fibrillated regenerated cellulose fibers before fibrillation is of primary importance to the strength of the separator, wherein longer fibers lead to a higher strength but also to more energy consumption during fibrillation. Preferably, the mean length of the fibrillated regenerated cellulose fibers before fibrillation is at least 2 mm and at most 8 mm and particularly preferably at least 3 mm and at most 6 mm.

Including the fibrillated regenerated cellulose fibers, at least 70% and at most 100% of the mass of the separator according to the invention is formed by cellulose fibers. Preferably, the proportion of cellulose fibers is at least 75% and at most 95% with respect to the mass of the separator. This type and amount of fibers in the separator enable a good strength to be obtained, so that the separator can also be processed into an electrochemical element.

As a complement to the fibrillated regenerated cellulose fibers, the cellulose fibers can also be formed by non-fibrillated regenerated cellulose fibers or by pulp fibers or mixtures thereof, wherein the pulp fibers are preferably sourced from coniferous wood, deciduous wood or other plants such as hemp, flax, jute, ramie, kenaf, kapok, coconut, abacá, sisal, bamboo, cotton, or esparto grass, or from recycled paper. Mixtures of pulp fibers of different origin can also be used for manufacturing the separator. Particularly preferably, the pulp fibers are sourced from deciduous wood or coniferous wood.

Particularly preferably, the cellulose fibers are a mixture of regenerated cellulose fibers, i.e., fibrillated and optionally non-fibrillated regenerated cellulose fibers, and pulp fibers. In a particular preferred embodiment, the ratio of the masses of the regenerated cellulose fibers to pulp fibers is at least 1:1 and at most 30:1, preferably at least 2:1 and at most 20:1, wherein, however, at least 50% of the mass of the separator has to be formed by fibrillated regenerated cellulose fibers and the cellulose fibers in the separator in total have to make up at least 70% and at most 100% of the mass of the separator.

Particularly preferably, the pulp fibers are at least partially micro-fibrillated pulp fibers, nano-fibrillated pulp fibers or pulp fibers with a mean length-weighted length of at most 0.2 mm, preferably at most 0.15 mm. These types of pulp fibers are particularly well suited to providing the separator with a small mean pore size and a small standard deviation for the pore size distribution.

in addition to the cellulose fibers, the separator according to the invention can also contain further fibers. These can include, for example, fibers produced from cellulose derivatives, glass fibers, plastic fibers such as, for example, fibers produced from polyolefins such as polyethylene or polypropylene; from polyesters such as polyethylene terephthalate or polylactic acids; from polyarylates such as poly(4-hydroxybenzoic acid-co-6-hydroxy-2-naphthoic acid); from polyethers, polysulfones, polyurethanes, polyamides, aromatic polyamides such as poly(p-phenylene terephthalamide); polyimides, polyvinyl alcohol, polyacrylates such as polyacrylonitrile or poly(acrylonitrile-co-methyl acrylate); polyphenylene sulfide or from poly(ethylene-co-vinyl acetate).

Preferably, the proportion of fibers other than cellulose fibers is in total, however, at most 30%, particularly preferably at most 20% of the mass of the separator. Such fibers in general do not bond to each other by hydrogen bonding and thus cannot contribute as well as the cellulose fibers to a high 0.1% yield point. An exception are fibers produced from polyvinyl alcohol, which can also form hydrogen bonds and are therefore particularly preferred.

The separator according to the invention can contain further components, which the skilled person can select appropriately for the manufacturing process according to his experience; this includes, for example, polyvinyl alcohol, polyethylene glycol, polyvinylidene fluoride, guaran, starch, carboxymethyl cellulose, methyl cellulose, dialdehydes such as glyoxal and inorganic fillers such as kaolin, titanium dioxide (TiO₂), silicon dioxide (SiO₂), aluminum oxide (Al₂O₃), zirconium dioxide (ZrO₂) or calcium carbonate (CaCO₃).

The amount of inorganic fillers in the separator is at most 30%, preferably at most 20% and particularly preferably at most 15% of the mass of the separator.

The separator according to the invention is calendered, which means that during manufacture of the separator, the fibrous web runs through at least one nip in which mechanical pressure is exerted on the fibrous web in the thickness direction. Calendering reduces the thickness and reduces the pore size, but also reduces the total porosity of the separator. A particular effect of the calendering in accordance with the process according to the invention consists in flattening the fibrillated regenerated cellulose fibers, as was explained with reference to FIG. 2. In this regard, certain settings are beneficial to calendering; these are described in more detail further below in connection with the process according to the invention.

Under a tensile load in the machine direction in accordance with ISO 1924-2:2008, the separator according to the invention reaches its 0.1% yield point at an elongation of no less than 0.5% and no more than 2.0%, preferably no less than 0.55% and no more than 2.0% and particularly preferably no less than 0.6% and no more than 1.0%.

Under tensile load in the machine direction in accordance with ISO 1924-2:2008, the separator according to the invention preferably reaches its 0.1% yield point at a tensile stress, with respect to width, of at least 0.1 kN/m and at most 2.0 kN/m, particularly preferably at least 0.15 kN/m and at most 1.6 kN/m. With respect to the cross-sectional area, the tensile stress in the machine direction at the 0.1% yield point is preferably at least 15 MPa and at most 30 MPa, particularly preferably at least 18 MPa and at most 28 MPa.

The Young's modulus in the machine direction in accordance with ISO 1924-2:2008 is preferably at least 1 GPa and at most 8 GPa, particularly preferably at least 2 GPa and at most 6 GPa. A high Young's modulus is of advantage, because the separator deforms less under load, but too high a Young's modulus is disadvantageous because, for example, a forced elongation due to speed differences leads to high forces in the separator and it can tear.

The elastic energy absorption in the machine direction with respect to the area is preferably at least 0.05 J/m² and at most 0.8 J/m², particularly preferably at least 0.10 J/m² and at most 0.60 J/m². The elastic energy absorption in the machine direction with respect to the volume is at least 4 kJ/m³ and at most 15 kJ/m³ and particularly preferably at least 5 kJ/m³ and at most 13 kJ/m³. A high elastic energy absorption is achieved by a high stress and elongation at the 0.1% yield point and allows high mechanical loads during processing of the separator to be compensated for without causing irreversible deformation to the separator.

The width-related tensile strength in accordance with ISO 1924-2:2008 in the machine direction for the separator according to the invention is preferably at least 0.3 kN/m and at most 2.0 kN/m, particularly preferably at least 0.5 kN/m and at most 1.5 kN/m. With respect to the cross-sectional area, the tensile strength in the machine direction of the separator according to the invention is preferably at least 20 MPa and at most 60 MPa, particularly preferably at least 30 MPa and at most 50 MPa.

The elongation at break in accordance with ISO 1924-2:2008 in the machine direction for the separator according to the invention is preferably at least 0.5% and at most 5.0%, particularly preferably at least 1.0% and at most 4.0%.

Surprisingly, the inventors have found that the separator according to the invention has good mechanical properties in the cross-direction as well, in particular a high elongation at break, which cannot be achieved with separators from the prior art. The high elongation at break results from setting a small average angle at which the cellulose fibers cross each other, as was explained in the description with reference to FIG. 3. The angle can be influenced during manufacture of the separator by the web tension and by other settings such as temperature or moisture that will be further described below with respect to the process according to the invention.

Thus, the separator according to the invention has higher dimensional stability in the cross direction as well, and tolerates higher mechanical loads during manufacture of an electrochemical element without deforming irreversibly. Furthermore, it has an exceptionally high elongation at break in the cross direction. All this is surprising, because according to the invention, the stretching of the fibers during manufacture of the separator is primarily in the machine direction.

Under tensile load in the cross direction in accordance with ISO 1924-2:2008, the separator according to the invention preferably reaches its 0.1% yield point at an elongation of no less than 0.4% and no more than 2.0%, particularly preferably no less than 0.45% and no more than 1.0%. Typical separators from the prior art have already reached their 0.1% yield point in the cross direction at an elongation of 0.2% to about 0.3%.

Under tensile load in the cross direction in accordance with ISO 1924-2:2008, the separator according to the invention preferably reaches its 0.1% yield point at a tensile stress with respect to width of at least 0.1 kN/m and at most 0.8 kN/m, particularly preferably at least 0.15 kN/m and at most 0.6 kN/m. With respect to the cross-sectional area, the tensile stress in the cross direction at the 0.1% yield point is preferably at least 8 MPa and at most 15 MPa, particularly preferably at least 10 MPa and at most 13 MPa.

The Young's modulus in the cross direction in accordance with ISO 1924-2:2008 is preferably at least 1 GPa and at most 6 GPa, particularly preferably at least 1.5 GPa and at most 5 GPa.

The elastic energy absorption with respect to area in the cross direction is preferably at least 0.04 J/m² and at most 0.25 J/m², particularly preferably at least 0.05 J/m² and at most 0.20 J/m². With respect to volume, the elastic energy absorption in the cross direction is preferably at least 1.5 kJ/m³ and at most 5.0 kJ/m³ and particularly preferably at least 2.0 kJ/m³ and at most 4.0 kJ/m³.

The tensile strength in accordance with ISO 1924-2:2008 in the cross direction for the separator according to the invention with respect to width is preferably at least 0.3 kN/m and at most 2.0 kN/m, particularly preferably at least 0.5 kN/m and at most 1.5 kN/m. With respect to the cross-sectional area, the tensile strength in the cross direction of the separator according to the invention is preferably at least 20 MPa and at most 60 MPa, particularly preferably at least 30 MPa and at most 50 MPa.

The elongation at break in accordance with ISO 1924-2:2008 in the cross direction for the separator according to the invention is preferably at least 1.0% and at most 8.0%, particularly preferably at least 2.0% and at most 7.0%.

An important feature for the safety of the electrochemical element manufactured from the separator according to the invention is the shrinkage of the separator at elevated temperatures. Preferably, the shrinkage of the separator according to the invention after heating to 150° C. for 30 minutes is at least 0.4% and at most 1.2%, particularly preferably at least 0.45% and at most 1%.

The separator according to the invention should be thin, so that the ions flowing in the electrolyte only need to travel a short distance through the pores of the separator between the two electrodes and the electrochemical element manufactured therefrom has a high volumetric energy density. On the other hand, a certain thickness is required in order to electrically isolate the electrodes safely from each other and to achieve a good strength for the separator. Preferably, the thickness of the separator according to the invention is therefore at least 10 μm and at most 55 μm, particularly preferably at least 12 μm and most 35 μm. The thickness of the separator can be determined in accordance with ISO 534:2011 on a single sheet. It is substantially influenced by the settings for calendering of the separator and the basis weight.

The basis weight of the separator provides good strength, but thickness and material consumption also increase with basis weight. Preferably, the basis weight of the separator according to the invention is thus at least 8 g/m³ and at most 30 g/m², particularly preferably at least 12 g/m² and at most 25 g/m². The basis weight can be determined in accordance with ISO 536:2019.

The porosity of the separator is the ratio of the pore volume to the total volume of the separator and is usually expressed as a percentage. The porosity of the separator can be estimated from the thickness and the basis weight, measured in accordance with ISO 534:2011 and ISO 536:2019 respectively, and the density of the fibers, wherein a density of 1500 kg/m³ can be selected for the fibers. Using these assumptions, the porosity u can be approximately calculated as the ratio of the pore volume to the total volume of the separator

$$μ = 1 - \frac{2}{3} \frac{m}{d}$$

wherein m is the basis weight in g/m² and d is the thickness in μm, and the porosity is obtained as a value between 0 and 1 and can be converted into a percentage by multiplication by 100. The porosity should be as high as possible, but it is limited from above primarily by the required mechanical strength and the requirement that the pores should be as small as possible. Preferably, the porosity is at least 30% and at most 85%, particularly preferably at least 35% and at most 75%.

The pore size distribution, the mean flow pore size and the standard deviation of the mean flow pore size can be determined by capillary flow porosimetry in accordance with ASTM F316-03 (2019) Standard Test Methods of Pore Size Characteristics of Membrane Filters by Bubble Point and Mean Flow Pore Test. In this, the flow rate of a medium through the separator at increasing pressure differences is determined. This test method is particularly well suited for separators, because only pores which lead through the separator are detected, and the narrowest section of each pore determines the flow rate. These features of the pores are also important for the transfer of ions through the separator.

The pores in the separator should not exceed a certain size in order to limit the growth of dendrites on the electrodes, and they should all be of the same size, i.e., have a pore size distribution with a small standard deviation. Preferably, the mean flow pore size is thus at least 40 nm and at most 1000 nm, preferably at least 50 nm and at most 800 nm.

Typically, the pore sizes in the separator according to the invention are unimodally distributed, so that the width of the pore size distribution can be characterized well by the standard deviation of the mean flow pore size. The standard deviation of the mean flow pore size for the separator according to the invention is thus preferably at least 3 nm and at most 300 nm, particularly preferably at least 3 nm and at most 200 nm.

Because the measurement of the pore size distribution by capillary flow porosimetry requires effort, the pore structure of the separator can simply also be characterized by the Gurley air permeability. The air permeability is also a good measure for how rapidly the separator can absorb the electrolyte. A high rate of absorption is of advantage to productivity during manufacture of electrochemical elements. The Gurley air permeability can be determined in accordance with ISO 5636-5:2013 and is preferably at least 10 s and at most 450 s, preferably at least 20 s and at most 300 s.

The separator can be used in electrochemical elements. An electrochemical element according to the invention comprises two electrodes, an electrolyte and the separator according to the invention. Preferably, the electrochemical element is a capacitor, a hybrid capacitor, a super capacitor or an accumulator and particularly preferably, the electrochemical element is a lithium ion battery.

The separator according to the invention can be manufactured by a process according to the invention that comprises the following steps.
A—producing a fibrous web comprising cellulose fibers,
B—calendering the fibrous web from step A,
C—rolling up the fibrous web forming the separator,
wherein the amount and type of cellulose fibers in the fibrous web in step A are selected such that at least 50% of the mass of the separator in step C is formed by fibrillated regenerated cellulose fibers and in addition to the fibrillated regenerated cellulose fibers, at least 70% and at most 100% of the mass of the separator in step C is formed by cellulose fibers, and
wherein the production of the fibrous web in step A or the calendering of the fibrous web in step B is carried out in part at a web tension which is at least 20% and at most 50% of the width-related tensile strength in the machine direction that the fibrous web has directly before step B, and
wherein the separator obtained in step C reaches its 0.1% yield point under tensile load in the machine direction in accordance with ISO 1924-2:2008 at an elongation of no less than 0.5% and no more than 2.0%.

According to the findings of the inventors, an increase in the 0.1% yield point can be achieved, among other things, by partially exposing the fibrous web, during manufacture in step A or during calendering in step B, to a high tensile load in the machine direction which is between 20% and 50% of the width-related tensile strength (kN/m) of the fibrous web directly before step B. The inventors assume that because of the load, the fibers are stretched in the machine direction to that the fibers cross each other at smaller angles on average and the finished separator reacts to tensile loads by elastic behavior up to higher elongations, as has already been explained above with reference to FIG. 3.

The width-related tensile strength of the fibrous web directly before step B in the machine direction has turned out to be a suitable reference value according to the findings of the inventors. The tensile strength of the fibrous web has already been established directly before step B of the process according to the invention, so that it constitutes a representative value.

Preferably, the tensile load of the fibrous web in the machine direction during at least a part of step A or step B is at least 25% and at most 40%, particularly preferably at least 25% and at most 35% of the width-related tensile strength in the machine direction that the fibrous web has directly before step B. The tensile load of the fibrous web can be essentially influenced by the applied torque of the rolls for transporting the fibrous web through the device for manufacturing or for calendering.

Clearly, during a first execution of the process according to the invention, the width-related tensile strength that the fibrous web has directly before step B is not yet precisely known. The skilled person, however, can call upon experience based on fiber composition, fibrillation of the fibers and basis weight of the fibrous web to provide a relatively precise estimate of the tensile strength of the fibrous web directly before calendering in step B and can use it as a basis for setting the web tension. If the process runs in a stable manner, the web tension can be adapted even more precisely to the actually measured tensile strength of samples of the fibrous web that were taken directly before the calendering in step B. This step can be repeated multiple times.

The described tensile load on the fibrous web can be applied during manufacture of the fibrous web in step A or during calendering in step B.

Preferably, the manufacture of the fibrous web in step A is carried out in a paper machine and comprises the following steps A.1 to A.5,
A.1—providing an aqueous suspension comprising cellulose fibers,
A.2—fibrillating at least a part of the cellulose fibers in the suspension,
A.3—de-watering the suspension on a running wire to form a fibrous web,
A.4—de-watering the fibrous web by mechanical pressure,
A.5—drying the fibrous web.

In this preferred embodiment of the process according to the invention, the fibrous web can preferably be exposed to the described web tension in a drying section, step A.5, or in a press section, step A.4, of the paper machine. In this regard, the variation in which the fibrous web is exposed to said web tension in the press section, step A.4, is particularly preferred. While in the drying section, step A.5, the structure of the fibrous web has already partially consolidated, it can be influenced more easily in the press section, step A.4.

In some embodiments of the invention, it is possible to expose the fibrous web to said web tension on a separate device, different from the paper machine, and obtain the dimensional stability in this manner. This can preferably be carried out before or simultaneously with the calendering in step B.

Thus, the skilled person has a plurality of variations of the process available in order to increase the 0.1% yield point of the separator according to the invention and thereby obtain a separator with a high dimensional stability.

The inventors assume that an elevated moisture content for the fibrous web increases the mobility of the fibers and thus makes it easier to stretch the fibers with a tensile load. This is primarily true for the fibrillated regenerated cellulose fibers, which are strongly crimped in an undeformed state. Preferably, the mean moisture content of the fibrous web under a tensile load (to generate said web tension) in step A or B, which is between 20% and 50% of the width-related tensile strength in the machine direction of the fibrous web directly before step B, is thus at least 4% and at most 15%, particularly preferably at least 5% and at most 12%. If the moisture content is selected in the upper range of the intervals provided, then it is possible to select a lower tensile load for the fibrous web. In a particularly preferred embodiment of the process according to the invention, the mean moisture content of the fibrous web under a tensile load in step A or B, which is between 20% and 30% of the width-related tensile strength in the machine direction of the fibrous web directly before step B, is at least 8% and at most 15%.

Preferably, the moisture content of the fibrous web is homogeneous over the width of the fibrous web; however, in order to fulfill special requirements for the manufacturing process, a certain moisture content profile over the width can be produced in the fibrous web with means that are known in the prior art, for example, a spraying bar.

In step B, mechanical pressure is exerted orthogonally to the fibrous web on the fibrous web from step A in at least one nip, so that it is compressed in the thickness direction. The fibers are flattened by suitable settings for pressure and temperature in the nip or the nips and the contact area between the fibrillated regenerated cellulose fibers is increased, as is shown, appropriately enlarged, in FIG. 2. In this manner, the 0.1% yield point is shifted to higher stresses and elongations and the separator becomes more dimensionally stable.

Preferably, the number of nips in step B is higher and is at least 2 and at most 14, particularly preferably at least 3 and at most 10.

To carry out the calendering process, according to the findings of the inventors, it has been found to be advantageous for the rolls forming the nip or the nips to have an elevated temperature. Preferably, the mean temperature of all or a part of these rolls in step B is thus at least 25° C. and at most 140° C. and particularly preferably at least 50° C. and at most 140° C., in particular at least 80° C. and at most 140° C. At temperatures above 80° C., covalent cross-linking and fixation of the fiber structure can occur, which can further improve the 0.1% yield point.

The mechanical pressure in all or a part of the nips in step B is at least 80 kN/m and at most 400 kN/m, preferably at least 160 kN/m and at most 320 kN/m. The preferred intervals allow for a particularly good combination of several effects. This includes an increase in the contact area between the fibrillated regenerated cellulose fibers, the reduction of the thickness and the reduction of the mean pore size without reducing the porosity too much.

The amount of cellulose fibers in step A is selected such that at least 50% of the mass of the separator in step C is formed by fibrillated regenerated cellulose fibers. Preferably, however, the proportion of fibrillated regenerated cellulose fibers is higher and is at least 55% and at most 100%, and particularly preferably at least 60% and at most 95% of the mass of the separator in step C.

The fibrillated regenerated cellulose fibers are preferably solvent-spun regenerated cellulose fibers, particularly preferably Lyocell® fibers.

The mean linear density of the fibrillated regenerated cellulose fibers before fibrillation is at least 0.8 g/10000 m (0.8 dtex) and at most 3.0 g/10000 m (3.0 dtex) and particularly preferably at least 1.0 g/10000 m (1.0 dtex) and at most 2.5 g/10000 m (2.5 dtex).

The length of the fibrillated regenerated cellulose fibers before fibrillation is at least 2 mm and at most 8 mm and particularly preferably at least 3 mm and at most 6 mm.

Including the fibrillated regenerated cellulose fibers, at least 70% and at most 100% of the mass of the separator in step C is formed by cellulose fibers. Preferably, the proportion of cellulose fibers is at least 75% and at most 95% with respect to the mass of the separator in step C.

As a complement to the fibrillated regenerated cellulose fibers, the cellulose fibers can also be formed by non-fibrillated regenerated cellulose fibers or by pulp fibers or mixtures thereof, wherein the pulp fibers are preferably sourced from coniferous wood, deciduous wood or other plants such as hemp, flax, jute, ramie, kenaf, kapok, coconut, abacá, sisal, bamboo, cotton or esparto grass, or from recycled paper. Mixtures pf pulp fibers of different origin can also be used to manufacture the separator in step A. Particularly preferably, the pulp fibers are sourced from deciduous wood or coniferous wood.

Particularly preferably, the cellulose fibers are a mixture of regenerated cellulose fibers, i.e., fibrillated and optionally non-fibrillated regenerated cellulose fibers, and pulp fibers. In a particular embodiment the ratio of the masses of regenerated cellulose fibers to pulp fibers is at least 1:1 and at most 30:1, preferably at least 2:1 and at most 20:1, wherein, however, at least 50% of the mass of the separator in step C still has to be formed by fibrillated regenerated cellulose fibers and the cellulose fibers in the separator in total have to make up at least 70% and at most 100% of the mass of the separator in step C.

Particularly preferably, the cellulose fibers are at least in part micro-fibrillated pulp fibers, nano-fibrillated pulp fibers or pulp fibers with a mean length-weighted length of at most 0.2 mm, preferably of at most 0.15 mm.

In addition to the cellulose fibers, the separator in step C can also contain further fibers. These can include, for example, fibers from cellulose derivatives, glass fibers, plastic fibers such as, for example, fibers from polyolefins such as polyethylene or polypropylene; from polyesters such as polyethylene terephthalate or polylactic acids; from polyarylates such as poly(4-hydroxybenzoic acid-co-6-hydroxy-2-naphthoic acid); from polyethers, polysulfones, polyurethanes, polyamides, aromatic polyamides such as poly(p-phenylene terephthalamide); polyimides, polyvinyl alcohol, polyacrylates such as polyacrylonitrile or poly(acrylonitrile-co-methyl acrylate); polyphenylene sulfide or from poly(ethylene-co-vinyl acetate).

Preferably, the proportion of fibers other than the cellulose fibers is in total at most 30%, particularly preferably at most 20% of the mass of the separator in step C.

Under tensile load in the machine direction in accordance with ISO 1924-2:2008, the separator in step C reaches its 0.1% yield point at an elongation of no less than 0.5% and no more than 2.0%, preferably no less than 0.55% and no more than 2.0% and particularly preferably no less than 0.6% and no more than 1%.

Under tensile load in the machine direction in accordance with ISO 1924-2:2008, the separator in step C preferably reaches its 0.1% yield point at a tensile stress of at least 0.1 kN/m and at most 2.0 kN/m, particularly preferably at least 0.15 kN/m and at most 1.6 kN/m. With respect to the cross-sectional area, the tensile stress in the machine direction at the 0.1% yield point is preferably at least 15 MPa and at most 30 MPa, particularly preferably at least 18 MPa and at most 28 MPa.

The elastic energy absorption in the machine direction is preferably at least 0.05 J/m² and at most 0.8 J/m², particularly preferably at least 0.10 J/m² and at most 0.6 J/m². With respect to the volume, the elastic energy absorption in the machine direction is at least 4 kJ/m³ and at most 15 kJ/m³ and particularly preferably at least 5 kJ/m³ and at most 13 kJ/m³.

Under tensile load in the cross direction in accordance with ISO 1924-2:2008, the separator in step C preferably reaches its 0.1% yield point at an elongation of no less than 0.4% and no more than 2.0%, particularly preferably no less than 0.45% and no more than 1%.

Under tensile load in the cross direction in accordance with ISO 1924-2:2008, the separator in step C preferably reaches its 0.1% yield point at a tensile stress of at least 0.1 kN/m and at most 0.8 kN/m, particularly preferably at least 0.15 kN/m and at most 0.6 kN/m. With respect to the cross-sectional area, the tensile stress in the cross direction at the 0.1% yield point is preferably at least 8 MPa and at most 15 MPa, particularly preferably at least 10 MPa and at most 13 MPa.

The elastic energy absorption in the cross direction is preferably at least 0.04 J/m² and at most 0.25 J/m², particularly preferably at least 0.05 J/m² and at most 0.20 J/m². With respect to volume, the elastic energy absorption in the cross direction is preferably at least 1.5 kJ/m³ and at most 5 kJ/m³ and particularly preferably at least 2 kJ/m³ and at most 4 kJ/m³.

Further parameters of the separator in step C, such as the Young's modulus in the machine and cross direction, the tensile strength in the machine and cross direction, the elongation at break in the machine and cross direction, the shrinkage, the basis weight, the thickness, the porosity, the mean flow pore size, the standard deviation of the mean flow pore size and the air permeability, are valid in the indicated and preferred intervals as disclosed further above for the separator according to the invention.

### BRIEF DESCRIPTION OF THE FIGURES

FIG. 1 shows, by way of example, a stress-strain diagram for the determination of the 0.1% yield point.

FIG. 2 shows, by way of example, the contact area for fibrillated regenerated cellulose fibers crossing each other, before and after calendering in step B.

FIG. 3 shows, by way of example, the influence of the crossing angle between two cellulose fibers on the size of the contact area.

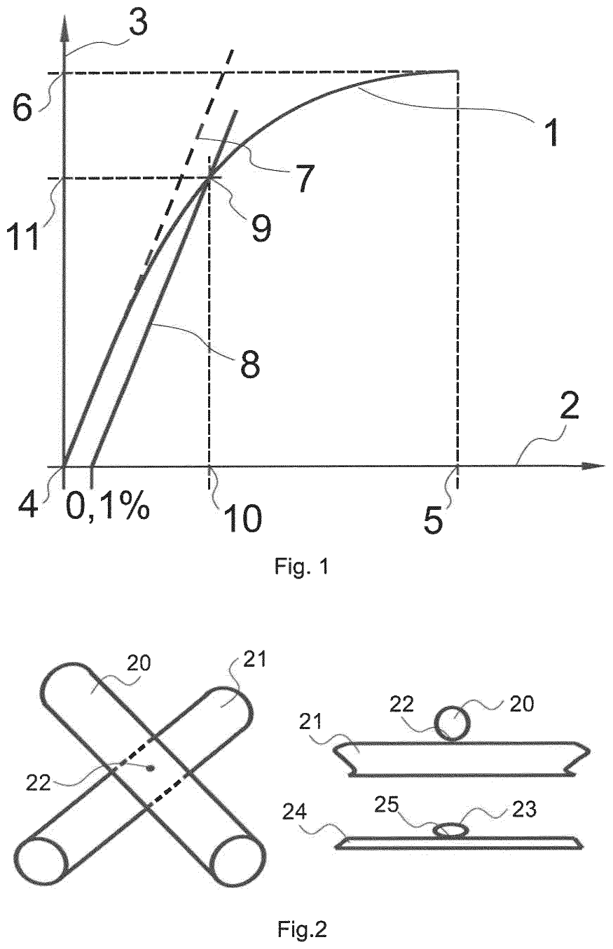

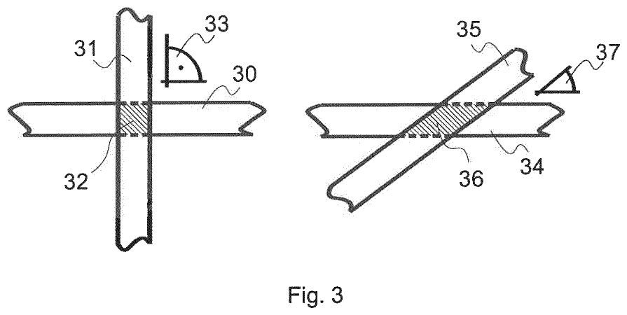

### DESCRIPTION OF SOME PREFERRED EMBODIMENTS

Some preferred embodiments of separators according to the invention and of the process according to the invention and separators not according to the invention as comparative examples will be described below.

### Example 1

In accordance with step A of the process according to the invention, a fibrous web was produced on a paper machine which, with respect to the mass of the finished separator, consisted of 77% fibrillated regenerated cellulose fibers, 13% nano-fibrillated pulp fibers and 10% fibers of polyethylene terephthalate (PET).

The fibrous web was calendered in a calender with 4 nips at a line load of 150 kN/m at a temperature of the rolls, forming the nips, of 130° C. in accordance with step B. Then the fibrous web was rolled up, step C, and thus the separator was obtained. The tensile strength of the fibrous web directly before calendering in step B was about 0.4 kN/m in the machine direction and corresponding to this tensile strength, various web tensions were selected directly before the start of the calendering process. The basis weight of the separator was 15.6 g/m² in accordance with ISO 536:2019 and the thickness of a single sheet, measured in accordance with ISO 534:2011, was about 22.3 μm. The tensile strength, elongation at break, Young's modulus and the stress-strain curve in accordance with ISO 1924-2:2008 were determined for the separators obtained in this manner and the 0.1% yield point and the elastic energy absorption were calculated therefrom.

The data for the machine direction are shown in Table 1 and for the cross direction in Table 2, wherein “WT/TS” is the ratio of the web tension directly before the start of calendering with respect to the width-related tensile strength of the fibrous web in the machine direction, directly before calendering, “LL” is the mechanical line load exerted in all nips during calendering, “TH” the thickness, “0.1%-YP” the 0.1% yield point with the corresponding stress in kN/m and MPa and the corresponding elongation in %, “EEA” the elastic energy absorption in J/m² and kJ/m³ and “YM” the Young's modulus in GPa.

TABLE 1

| | | | | Machine Direction | | | | | |
|---|---|---|---|---|---|---|---|---|---|
| | WT/TS | LL | TH | 0.1%-YP | | | EEA | | YM |
| Code | % | kN/m | μm | kN/m | MPa | % | J/m² | kJ/m³ | GPa |
| X | 10 | 150 | 22.5 | 0.25 | 11.1 | 0.40 | 0.05 | 2.4 | 3.6 |
| Y | 15 | 150 | 22.3 | 0.29 | 12.9 | 0.43 | 0.07 | 3.0 | 3.7 |
| A | 20 | 150 | 22.1 | 0.55 | 24.9 | 0.69 | 0.21 | 9.5 | 4.2 |
| B | 30 | 150 | 22.2 | 0.50 | 22.6 | 0.64 | 0.17 | 7.9 | 4.2 |
| C | 40 | 150 | 22.2 | 0.46 | 20.6 | 0.57 | 0.14 | 6.3 | 4.4 |

TABLE 2

| | | | | Cross Direction | | | | | |
|---|---|---|---|---|---|---|---|---|---|
| | WT/TS | LL | TH | 0.1%-YP | | | EEA | | YM |
| Code | % | kN/m | μm | kN/m | MPa | % | J/m² | kJ/m³ | GPa |
| X | 10 | 150 | 22.5 | 0.18 | 8.2 | 0.41 | 0.04 | 1.8 | 2.6 |
| Y | 15 | 150 | 22.3 | 0.19 | 8.4 | 0.40 | 0.04 | 1.8 | 2.6 |
| A | 20 | 150 | 22.1 | 0.28 | 12.5 | 0.61 | 0.09 | 4.2 | 2.5 |
| B | 30 | 150 | 22.3 | 0.25 | 11.4 | 0.57 | 0.08 | 3.6 | 2.5 |
| C | 40 | 150 | 22.2 | 0.25 | 11.1 | 0.58 | 0.08 | 3.5 | 2.4 |

Table 1 shows that both separators not according to the invention X and Y reach their 0.1% yield point at a relatively low elongation of less than 0.45%. The Young's modulus in the machine direction of the separators according to the invention A, B and C is slightly higher than that of the separators not according to the invention X and Y, so that even at the same elongation, the separators according to the invention A, B and C can absorb more elastic energy and because of this alone are already dimensionally more stable.

It can also be seen that the elastic behavior can be extended to higher elongations if the web tension exceeds about 20% of the width-related tensile strength in the machine direction which the fibrous web has directly before step B. An increase in the ratio of the web tension to the width-related tensile strength in the machine direction of the separator of more than 20% is possible, but does not generate improvements for the 0.1% yield point.

The effect in the cross direction is surprising, because it was to be expected that at a tensile load in the machine direction during the manufacture, the mechanical properties in the cross direction of the finished separator would not change substantially or would in fact deteriorate. The experiments, however, show that even in the cross direction, the 0.1% yield point is shifted to higher stresses and elongations and thus also the elastic energy absorption in the cross direction can be substantially increased.

The pore structure of the separator A according to the invention was determined by capillary flow porosimetry in accordance with ASTM F316-03 (2019). The mean flow pore size was 173 nm at a standard deviation of 150 nm. The porosity was 45% and the Gurley air permeability in accordance with ISO 5636-5:2013 was 54 s.

Due to the mechanical properties and the pore structure, the separators A, B and C according to the invention are well suited for the manufacture of electrochemical elements and the experimental production of lithium ion batteries was possible without any problems.

### Example 2

A fibrous web was produced on a paper machine in accordance with step A of the process according to the invention which, with respect to the mass of the finished separator, consisted of 90% fibrillated regenerated cellulose fibers and 10% of nano-fibrillated pulp fibers.

The fibrous web was calendered in a calender with 6 nips at various line loads from 80 kN/m to 400 kN/m at a temperature of the rolls forming the nips of 90° C. in accordance with step B. Then the fibrous web was rolled up, step C, and thus several separators were obtained. The width-related tensile strength of the fibrous web directly before calendering in step B in the machine direction was about 0.44 kN/m to 0.46 kN/m and corresponding to this tensile strength, the fibrous web was exposed to various web tensions in the drying section in step A, wherein the fibrous web was moistened in the size press before this zone of the drying section. The basis weight of the separator was about 15.6 g/m² in accordance with ISO 536:2019. The tensile strength, elongation at break, Young's modulus and the stress-strain curve in accordance with ISO 1924-2:2008 were determined for the separators obtained in this manner and the 0.1% yield point and the elastic energy absorption were calculated therefrom.

The data are shown for the machine direction in Table 3 and for the cross direction in Table 4, wherein “WT/TS” is the ratio of the web tension in the drying section of step A to the width-related tensile strength of the fibrous web in the machine direction directly before calendering, “LL” is the mechanical line load exerted in all nips during calendering, “TH” the thickness, “0.1%-YP” the 0.1% yield point with the corresponding stress in kN/m and MPa and the corresponding elongation in %, “EEA” the elastic energy absorption in J/m² and kJ/m³ and “YM” the Young's modulus in GPa.

TABLE 3

| | | | | Machine Direction | | | | | |
|---|---|---|---|---|---|---|---|---|---|
| | WT/TS | LL | TH | 0.1%-YP | | | EEA | | YM |
| Code | % | kN/m | μm | kN/m | MPa | % | J/m² | kJ/m³ | GPa |
| V | 10 | 240 | 20.3 | 0.28 | 13.8 | 0.47 | 0.07 | 3.5 | 3.8 |
| W | 15 | 240 | 20.2 | 0.31 | 15.5 | 0.49 | 0.08 | 4.1 | 3.9 |
| D | 20 | 240 | 20.0 | 0.47 | 23.6 | 0.67 | 0.17 | 8.6 | 4.2 |
| E | 30 | 240 | 20.1 | 0.54 | 26.9 | 0.65 | 0.19 | 9.5 | 4.7 |
| F | 40 | 240 | 20.2 | 0.51 | 25.5 | 0.61 | 0.17 | 8.4 | 4.8 |
| G | 25 | 80 | 20.8 | 0.55 | 26.3 | 0.72 | 0.21 | 10.3 | 4.1 |
| H | 25 | 400 | 19.4 | 0.46 | 23.8 | 0.56 | 0.14 | 7.1 | 5.0 |

TABLE 4

| | | | | Cross Direction | | | | | |
|---|---|---|---|---|---|---|---|---|---|
| | WT/TS | LL | TH | 0.1%-YP | | | EEA | | YM |
| Code | % | kN/m | μm | kN/m | MPa | % | J/m² | kJ/m³ | GPa |
| V | 10 | 240 | 20.3 | 0.16 | 7.8 | 0.40 | 0.03 | 1.7 | 2.6 |
| W | 15 | 240 | 20.2 | 0.16 | 7.7 | 0.39 | 0.03 | 1.6 | 2.5 |
| D | 20 | 240 | 20.0 | 0.20 | 9.9 | 0.49 | 0.05 | 2.7 | 2.4 |
| E | 30 | 240 | 20.1 | 0.21 | 10.3 | 0.50 | 0.06 | 2.8 | 2.4 |
| F | 40 | 240 | 20.2 | 0.19 | 9.3 | 0.48 | 0.05 | 2.4 | 2.2 |
| G | 25 | 80 | 20.8 | 0.19 | 9.3 | 0.52 | 0.05 | 2.6 | 2.0 |
| H | 25 | 400 | 19.4 | 0.18 | 9.2 | 0.45 | 0.04 | 2.2 | 2.4 |

Table 3 shows that both separators V and W not according to the invention reach their 0.1% yield point in the machine direction at an elongation of 0.47% and 0.49% respectively. The Young's modulus of the separators D, E, F, G and H according to the invention is slightly higher than that of the separators V and W not according to the invention, so that even at the same elongation, the separators D to H according to the invention can absorb more elastic energy and because of this alone are already dimensionally more stable.

It can also be seen that the elastic behavior can be extended to higher elongations if the web tension in the drying section in step A exceeds about 20% of the width-related tensile strength in the machine direction which the fibrous web has directly before calendering. An increase in the ratio of the web tension to the width-related tensile strength in the machine direction of the fibrous web directly before calendering of more than 20% is possible, and in part provides further improvements in the 0.1% yield point and the elastic energy absorption.

A comparison of the separators D, G and H according to the invention shows that the line loads during calendering have an influence on the elastic energy absorption. At high line loads, the elastic energy absorption in the machine direction and in the cross direction decreases.

For the separators D to H according to the invention, the tensile strength in accordance with ISO 1924-2:2008 showed an elongation at break in the cross direction of 5.5% to 7.3%, which is a very high value. For comparison, the elongation at break in the cross direction for the separators V and W not according to the invention was less than 5%. This is a further advantage of the process according to the invention.

The Gurley air permeability of the separators according to the invention, in accordance with ISO 5636-5:2013, was between 140 s and 250 s and the mean flow pore size was between 130 nm and 160 nm with a standard deviation of the mean flow pore size of 80 nm to 150 nm, for which reason it has to be assumed that the pore structure is appropriate for use as a separator in an electrochemical element.

The manufacture of lithium ion batteries from the separators D to H according to the invention was possible without any problems.

The separators X, Y, V and W not according to the invention are suitable for the manufacture of electrochemical elements, but the separators A to H according to the invention have better mechanical properties so that electrochemical elements with better performance parameters can be manufactured with higher productivities.

1. Separator for an electrochemical element, in which at least 50% of the mass of the separator is formed by fibrillated regenerated cellulose fibers wherein, including the fibrillated regenerated cellulose fibers, at least 70% and at most 100% of the mass of the separator is formed by cellulose fibers, wherein the separator is calendered, and wherein under tensile load in the machine direction in accordance with ISO 1924-2:2008, the separator reaches its 0.1% yield point at an elongation of no less than 0.5% and no more than 2.0%.

2. Separator according to claim 1, in which the proportion of fibrillated regenerated cellulose fibers is at least 60% and at most 95% of the mass of the separator.

3. (canceled)

4. Separator according to claim 1, in which the mean linear density of the fibrillated regenerated cellulose fibers before fibrillation is at least 0.8 g/10000 m (0.8 dtex) and at most 3.0 g/10000 m (3.0 dtex).

5. Separator according to claim 1, in which the mean length of the fibrillated regenerated cellulose fibers before fibrillation is at least 3 mm and at most 6 mm.

6. (canceled)

7. (canceled)

8. (canceled)

9. Separator according to claim 1, in which the cellulose fibers are a mixture of regenerated cellulose fibers or pulp fibers, wherein in all cases, the regenerated cellulose fibers contain fibrillated and optionally non-fibrillated regenerated cellulose fibers, and wherein the ratio of the masses of regenerated cellulose fibers to pulp fibers is at least 1:1 and at most 30:1, under the condition that at least 50% of the mass of the separator is formed by fibrillated regenerated cellulose fibers and the cellulose fibers in the separator in total make up at least 70% and at most 100% of the mass of the separator.

10. Separator according to claim 1, in which the pulp fibers are at least in part micro-fibrillated pulp fibers, nano-fibrillated pulp fibers or pulp fibers with a length-weighted mean length of at most 0.2 mm.

11. (canceled)

12. (canceled)

13. (canceled)

14. (canceled)

15. Separator according to claim 1, which, under tensile load in the machine direction in accordance with ISO 1924-2:2008, reaches its 0.1% yield point at an elongation of no less than 0.6% and no more than 1.0%.

16. Separator according to claim 1, which, under tensile load in the machine direction in accordance with ISO 1924-2:2008, reaches its 0.1% yield point at a width-related tensile stress of at least 0.1 kN/m and at most 2.0 kN/m.

17. Separator according to claim 1, which, under tensile load in the machine direction in accordance with ISO 1924-2:2008, reaches its 0.1% yield point at a tensile stress with respect to cross-sectional area of at least 15 MPa and at most 30 MPa.

18. (canceled)

19. Separator according to claim 1, with an elastic energy absorption with respect to area in the machine direction of at least 0.05 J/m² and at most 0.80 J/m².

20. Separator according to claim 1, with an elastic energy absorption with respect to volume in the machine direction of at least 4 kJ/m³ and at most 15 kJ/m³.

21. (canceled)

22. (canceled)

23. Separator according to claim 1, with an elongation at break in the machine direction in accordance with ISO 1924-2:2008 of at at least 1.0% and at most 4.0%.

24. Separator according to claim 1, which, under tensile load in the cross direction in accordance with ISO 1924-2:2008, reaches its 0.1% yield point at an elongation of no less than 0.4% and no more than 2.0%.

25. Separator according to claim 1, which, under tensile load in the cross direction in accordance with ISO 1924-2:2008, reaches its 0.1% yield point at a width-related tensile stress of at least 0.1 kN/m and at most 0.8 kN/m.

26. (canceled)

27. (canceled)

28. Separator according to claim 1, with an elastic energy absorption with respect to area in the cross direction of at least 0.04 J/m² and at most 0.25 J/m².

29. Separator according to claim 1, with an elastic energy absorption with respect to volume in the cross direction of at least 1.5 kJ/m³ and at most 5.0 kJ/m³.

30. Separator according to claim 1, with a width-related tensile strength in the cross direction in accordance with ISO 1924-2:2008 of at least 0.3 kN/m and at most 2.0 kN/m.

31. (canceled)

32. Separator according to claim 1, with an elongation at break in the cross direction in accordance with ISO 1924-2:2008 of at least 1.0% and at most 8.0%.

33. (canceled)

34. Separator according to claim 1, with a thickness, determined on a single sheet in accordance with ISO 534:2011, of at least 12 μm and at most 35 μm.

35. Separator according to claim 1, with a basis weight in accordance with ISO 536:2019 of at least 12 g/m² and at most 25 g/m².

36. Separator according to claim 1, with a porosity μ of at least 35% and at most 75%, wherein the porosity u is calculated according to
$$μ = 1 - \frac{2}{3} \frac{m}{d} ,$$
wherein m is the basis weight in g/m² and d is the thickness in μm and the porosity is obtained as a value between 0 and 1 and is converted into a percentage by multiplication by 100.

37. (canceled)

38. Separator according to claim 1, in which the standard deviation of the mean flow pore size is at least 3 nm and at most 300 nm.

39. (canceled)

40. Electrochemical element, which comprises two electrodes, an electrolyte and a separator according to claim 1, wherein the electrochemical element is formed by a capacitor, a hybrid capacitor, a super capacitor or an accumulator, or a lithium ion battery.

41. Process for manufacturing a separator, with the following steps:
A—manufacturing a fibrous web comprising cellulose fibers,
B—calendering the fibrous web from step A,
C—rolling up the fibrous web forming the separator,
wherein the amount and type of cellulose fibers in the fibrous web in step A is selected such that at least 50% of the mass of the separator in step C is formed by fibrillated regenerated cellulose fibers and, including the fibrillated regenerated cellulose fibers, at least 70% and at most 100% of the mass of the separator in step C is formed by cellulose fibers, wherein the manufacture of the fibrous web in step A or the calendering of the fibrous web in step B is carried out at least in part at a web tension which is at least 20% and at most 50% of the width-related tensile strength in the machine direction that the fibrous web has directly before step B, and wherein, under tensile load in the machine direction in accordance with ISO 1924-2:2008, the separator obtained in step C reaches its 0.1% yield point at an elongation of no less than 0.5% and no more than 2.0%.

42. Process according to claim 41, in which a tensile load of the fibrous web in the machine direction for generating said web tension during at least a part of step A or step B is at least 25% and at most 40% of the width-related tensile strength of the fibrous web in the machine direction that the fibrous web has directly before step B.

43. Process according to claim 41, in which the manufacture of the fibrous web in step A is carried out in a paper machine and comprises the following steps A.1 to A.5:
A.1—providing an aqueous suspension comprising cellulose fibers,
A.2—fibrillating at least a part of the cellulose fibers in the suspension,
A.3—de-watering the suspension on a running wire to form a fibrous web,
A.4—de-watering the fibrous web by mechanical pressure,
A.5—drying the fibrous web.

44. Process according to claim 43, in which the fibrous web is exposed to said web tension during step A.5 in a drying section or during step A.4 in a press section of the paper machine.

45. Process according to claim 41, in which the mean moisture content of the fibrous web under a tensile load in step A or B to generate said web tension, which is between 20% and 50% of the width-related tensile strength of the fibrous web in the machine direction directly before step B, is at least 4% and at most 15%.

46. Process according to claim 41, in which the mean moisture content of the fibrous web under a tensile load in step A or B to generate said web tension, which is between 20% and 30% of the width-related tensile strength of the fibrous web in the machine direction directly before step B, is at least 8% and at most 15%.

47. Process according to claim 41, in which the fibrous web in step B passes through at least 2 and at most 14, wherein a mechanical pressure in all or at least a part of the nips in step B is at least 80 kN/m and at most 400 kN/m.

48. Process according to claim 41, in which the calendering in step B is carried out by means of a plurality of rolls, wherein the mean temperature of all or a part of these rolls in step B at least 50° C. and at most 140° C.

49. (canceled)

50. (canceled)

51. (canceled)

52. (canceled)

53. Process according to claim 41, in which the separator in step C is a separator according to claim 1.
